(19) United States
(12) Patent Application Publication
(10) Pub. No.: US 2005/0035594 A1
(43) Pub. Date: Feb. 17, 2005

(54) Weatherproof compression connecting assembly for securing electrical metal tubing

(76) Inventor: Kenneth M. Kiely, Milford, CT (US)

Correspondence Address: Arthur T. Fattibene;Fattibene and Fattibene, 2480 Post Road, Southport, CT, 06890, US

(21) Appl. No.: 10/639,907

(22) Filed: Aug. 13, 2003

(51) Int. Cl. F16L 3/04; F16L 5/00; F16L 27/00

(52) U.S. Cl. 285/154.1; 285/137.11

(57) ABSTRACT

A rain or water proof connecting assembly for securing electrical metal tubing to a junction box and the like having a connecting body with a bore defining opposed open ends and an electrical metal tubing or conduit adapted to be received in at least one open end. The open end receiving the metal tubing includes an internal portion sized to snugly receive the end of the metal tubing or conduit and a diverging or tapered internal surface portion immediately adjacent the open end. Fitted onto the securing end of the metal tubing is a sealing gland having a complementary tapered outer surface and a split compression ring arranged so that when assembled, the sealing gland provides a fluid tight seal and the split ring effects a mechanically tight and electrically grounded connection between the connecting body and the metal conduit.

### FIELD OF THE INVENTION

This invention is directed to a connecting assembly for securing electrical metal conduit, and more specifically to a weatherproof compression connector or coupling assembly having a watertight sealing gland and an electrical grounding compression ring that is compressively fitted onto the connected end of the conduit for shielding therein an electrical conductor or cable.

### BACKGROUND OF THE INVENTION

Heretofore it was common practice to secure a conduit that shields electrical conductors, wires or cables by inserting one end of a conduit into an externally threaded inlet end of a connecting body and securing the conduit to the threaded inlet end of the connecting body by a suitable tightening nut. The outlet end of the connecting body in turn was secured to an electrical junction box by inserting the other or outlet end of the connecting body into the knockout hole of the electrical junction box and securing the same by a locking nut or other suitable means, e.g. a snap fit retaining means as disclosed in a co-pending patent application Ser. No. 10/283,978 filed Oct. 30, 2002, which is incorporated herein by reference. It has been noted that such prior known connecting assemblies did not prohibit rain or water from seeking its way through the connection. Also, electrical grounding of conduits was not at all times positive.

### SUMMARY OF THE INVENTION

An object of this invention is to provide an improved coupling or connector assembly which is capable of prohibiting water or rain from seeping through the coupling or connector assembly.

Another object is to provide an improved coupling or connector assembly capable of effecting a positive electrical grounding of a conduit connected thereto.

Another object is to provide an improved electrical coupling or connector assembly that is relatively simple to fabricate, easy to assemble and positive in operation.

The foregoing objects and other features and advantages are readily obtained by a connector or coupling assembly that includes a connector or coupling body provided with an inlet end having an opening adapted to receive a conduit, and an outlet having an opening through which the electrical conductors, wires, or cables adapted to be inserted through the conduit may extend. The external surface of the inlet end is threaded to receive a connecting nut for securing the conduit to the inlet end. The connector or coupling body is provided with a through bore having a shoulder formed intermediate the length thereof to define a stop to limit the distance a conduit may be inserted thereinto. The internal surface of the inlet end of the connector or coupling body is provided with a second ridge or stop, disposed between the intermediate shoulder stop and the opening to the inlet end. The internal surface of the inlet end defined between the conduit shoulder stop and the ridge stop or first portion is generally shaped and sized to snugly receive the outer surface of the conduit. The internal surface of the inlet end disposed between the ridge stop and the inlet opening or second portion is provided with a taper that diverges toward the inlet opening.

To effect a waterproof seal and a positive electric ground for the conduit, a metallic split compression ring is fitted onto the end of the conduit. Also fitted onto the end of the conduit is a plastic sealing ring having the outer surface thereof tapered to complement the internal tapered portion of the connector or coupling inlet end. The arrangement is such that as the connecting nut is tightened onto the threaded inlet end, the metallic split compression ring simultaneously urges the plastic sealing ring into a positive sealing relationship between the conduit and the inlet end of the connector or coupling as the split metallic ring is compressed onto the conduit to insure a positive electric grounding of the conduit while imparting a friction holding force sufficient to prohibit the conduit from being pulled out of the connector or coupling body.

Other features and advantages will become readily apparent in view of the following detailed description and drawings.

### IN THE DRAWINGS

FIG. 1 is a perspective view of an assembled conduit connector embodying the present invention.

FIG. 2 is an expanded perspective view illustrating the component parts of an conduit connector embodying the invention.

FIG. 3 is a side sectional view of the connector assembly embodying the invention taken along line 3-3 on FIG. 1.

FIG. 4 is a plan view of the sealing gland component.

FIG. 5 is an enlarged sectional view taken along line 5-5 on FIG. 4.

FIG. 6 is a side view of the sealing gland component.

FIG. 7 is a sectional view taken along line 7-7 on FIG. 2.

FIG. 8 is a sectional side view of a coupling assembly embodying the invention.

### DETAILED DESCRIPTION OF THE PREFERRED EMBODIMENTS

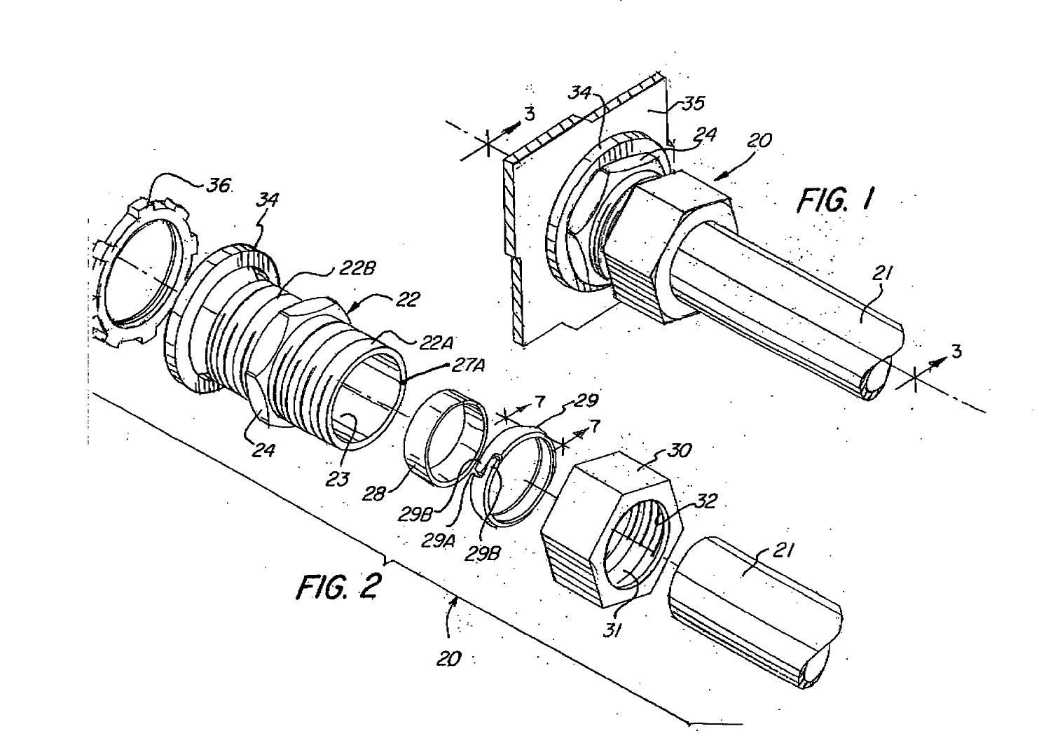

Referring to the drawings, there is illustrated in FIGS. 1 and 2 a connecting assembly embodying the invention. A connecting assembly as broadly defined herein means either a connector assembly 20, by which a conduit 21 is connected to an electrical junction box 22 as shown in FIG. 1, or coupling assembly 40 as shown in FIG. 8 for coupling two conduits 41A and 41B in end to end relationship.

The illustrated embodiment of the invention as depicted in FIGS. 1 to 7 is directed to a connector assembly 20 which includes a connector body 22 which is generally formed as zinc casting or other suitable metal. The connector body 22 includes an inlet end 22A and an outlet end 22B. In the illustrated embodiment of FIGS. 1 and 2, the outer surfaces of the inlet end 22A and outlet end 22B are provided with suitable external threads. The connector body 22 also includes a through bore 23, as will be hereinafter described in more detail. Intermediate the inlet end 22A and outlet end 22B, the connector body 22 is provided with a radially outwardly extending flange 24 having a hexagonal shape. However, it will be understood that the flange 24 may assume any suitable shape that will facilitate gripping the same for purposes of assembling.

Intermediate between the inlet opening 27A and the outlet opening 27B of the through bore 23 there is formed an internal shoulder 25 which functions as a stop to limit the distance a conduit 21 can be inserted into the inlet end 22A of the connector body 22. Generally, such conduits are formed of metal, e.g. steel and the like.

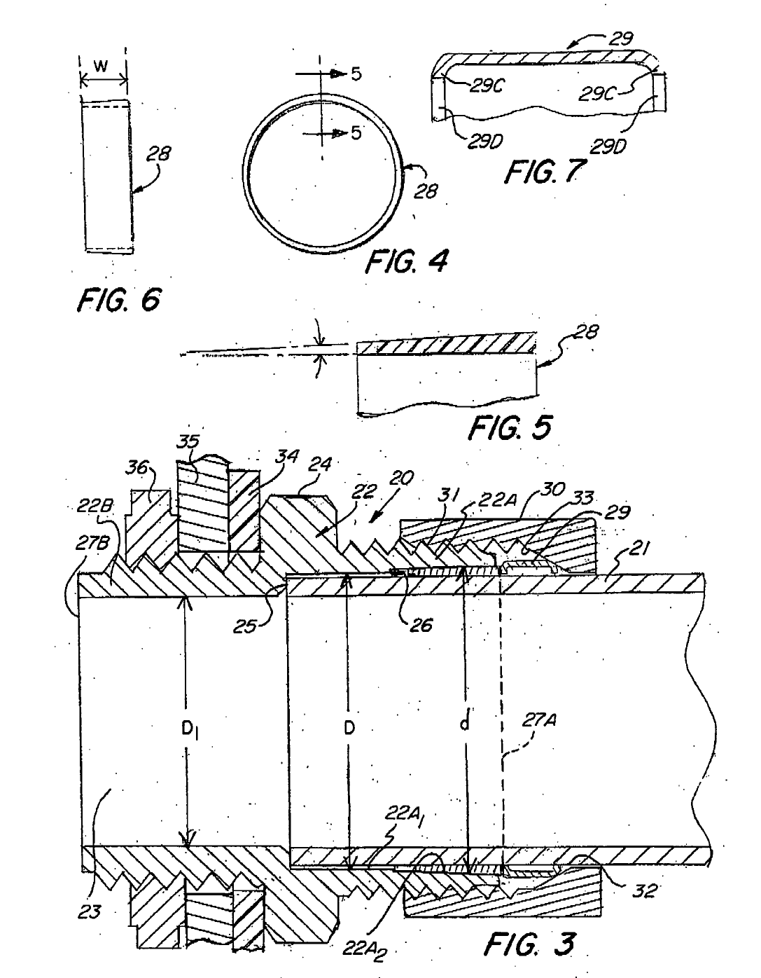

In accordance with this invention, the portion of the through bore 23 defining the distal portion 22A₁ of the inlet end 22A, adjacent the stop shoulder 25, or first portion has a substantially uniform diameter D of a size and shape to snugly receive the end portion of the conduit as shown in FIG. 3. The distal or first portion 22A₁ of the inlet end 22 extends from the stop shoulder 25 to an intermediate ridge or shoulder 26 located at a point intermediate of the inlet opening 27A and the shoulder stop 25. The internal surface of the through bore 23 extending from the intermediate shoulder 26 to the inlet opening 27A or second portion 22A₂ tapers outwardly so that the diameter d of proximate end or second portion 22A₂ progressively increases toward the inlet opening 27A. The portion of the bore 23 defining the outlet end 22B has a diameter D₁ which is slightly less than diameter D, as determined by the thickness of the stop shoulder 25.

A sealing gland 28 in the form of a ring is snugly fitted onto the end of the conduit 21 that is inserted into the inlet end 22A of the connector body 22. The sealing gland 28 is provided with a width W which is arranged to be received into the proximate or tapered portion 22A₂ of the inlet end 22A. As best seen in FIG. 5, the external periphery of the sealing gland 28 is tapered to complement the taper defined by the inner surface of the proximate portion 22A₂ of the inlet end 22A. Preferably, the width W of the sealing gland 28 is substantially equal to the length of the tapered portion 22A₂.

Also positioned onto the end of the conduit 21 to be inserted into the inlet end 22A, and preceding the placement of the sealing gland 28 onto the conduit 21 is a split compression ring 29. Referring to FIG. 3, the compression ring 29 is preferably formed of a spring steel or the like with a diameter sized so as to be loosely fitted onto the conduit 21. The compression ring 29 is provided with a transverse slot or cut 29A as best seen in FIG. 2, to define a small space or gap between the opposed ends of the ring 29. As shown in FIG. 3, the cut or slot 29A that defines the split ring 29 forms opposed, juxtapositioned, slightly spaced apart tongues 29B, 29B. Thus, the cut 29A defines spaced tongues 29B, 29B that are longitudinally extended and disposed in a common plane to define a split ring of 360°.

In the illustrated embodiment, the opposed edges of the compression ring 29 are slightly offset or bent to define lips 29C, 29C that extend about the opposed peripheries of the ring 29. The arrangement is such that when the ring 29 is compressed, the peripheral surface 29D defined by the opposed lips 29B, 29B are arranged to engage the end of the conduit 21 with a force sufficient to prohibit the conduit 21 from becoming separated from the connector body 22 in the assembled position of the connector assembly while provided for a positive electrical ground.

A fastening nut 30 is provided for securing the conduit 21 to the inlet end of the connector body 22. The nut 30 is provided with internal threads 31 by which it can be threaded onto the external threads of the inlet end 22A of the connector body. The nut 30 is provided with an opening 32 sized to permit the nut 30 to be fitted onto the end of a conduit. Circumscribing the opening 32, the nut 30 is provided with a cam surface 33 arranged to engage the compression ring 29 as the nut 30 is threaded onto the inlet end 22A of the connector body 22 to secure the conduit to the connector body.

Completing the connector assembly 20 is a resilient washer 34 formed of a resilient plastic, rubber and the like, which is arranged to be fitted onto the outlet end 22B of the connector body 22. In operation, the washer 34 is fitted onto the outlet end 22B of the connector body 22 so as to be positioned between the flange 24 and the side wall 35 of a junction box or the like. A lock nut 36 or other suitable locking fastener is fitted onto the outlet end portion 22B of the connector to positively secure the connector body 22 to an electrical junction box or the like. As the locking nut 36 is tightened onto the outlet end 22B of the connector body 22, the resilient washer 34 is compressed or wedged between the flange 24 and the side wall 35 of the junction box. Accordingly, the resilient washer 34 provides a seal about the knockout opening of the junction box 35 that receives the outlet end portion 22A of the connector body.

In assembling the connector assembly 20, the fastening nut 30 is positioned onto the end of the conduit, as noted in FIG. 3. The compression ring 29 is then fitted onto the end of the conduit, followed by the positioning the sealing gland 28 onto the end of the conduit. With the fastening nut 30, compression ring 29 and sealing gland 28 thus positioned onto the end of the conduit, the conduit is inserted into the inlet end 22A until the end of the conduit 21 is brought into abutting relationship with stop shoulder 25. With the conduit 21 seated against the stop shoulder 25, the fastening nut 30 is tightened onto the inlet end 22A. In so tightening the nut 30, the cam surface 33 upon engaging the compression ring 29 will cause the compression ring to be urged against the sealing gland 28, causing the sealing gland 28 to wedge itself between the outer surface of the conduit 21 and the internal tapered surface of the inlet portion 22A₂ to form a fluid tight seal thereat while causing the split compression ring 29 to compress tightly onto the periphery of the conduit 21 to positively secure the connection so as to preclude any separation or pull out of the conduit 21 from the connector body 22. The compression ring 29 formed of a spring steel also insures a positive electrical grounding of the conduit and connector assembly.

It will be understood that the conduit 21 may be connected to the connector body 22 either before or after the connector body 22A has been attached to a juncture box 35 or the like. To secure the described connector body 22 to a juncture box 35, the resilient washer 34 is positioned on the outlet end 22B, which is then inserted through a knockout hole of a juncture box and secured thereto by the lock nut 36.

FIG. 8 illustrates a modified embodiment of the invention as applied to a coupler assembly 40 for connecting conduits 41A and 41B in end to end relationship. As shown, the coupler assembly 40 includes a coupling body 42 which may be formed of a suitable material, e.g. a zinc casting or the like. The coupler body 42 is provided with opposed inlet and outlet end portions 42A, 42B having a through bore 43. In the illustrated embodiment, the outer surfaces of the inlet and outlet portions 41A, 41B are externally threaded as indicated as 44. Between the opposed open end of the bore, there is provided on the internal surface thereof a circumscribing rib, ridge or shoulder 45. As will be noted, the shoulder 45 defines a stop to limit the insertion of conduits 41A, 41B into the opposed end portions of the coupling body 42.

The respective opposed end portions 42A, 42B are each provided with a bore portion 43A having a substantially uniform diameter sized to snugly receive the outer diameter of the conduit to be fitted thereinto, and an internally tapered portion 43B similar to that hereinbefore described with respect to the connector body 22.

Externally, the coupling body 42 is provided with an external radial flange 45A having a shape that can be readily gripped to effect the turning thereof if necessary. The external surfaces of the respective opposed ends of the coupler body 42 are suitably threaded for receiving a fastening nut 46 similar to the fastening nut 30 hereinbefore described.

A sealing gland 47 and a compressing ring 48, in the form hereinbefore described, is fitted onto each end of the respective conduits 41A, 41B to complete the assembly, as hereinbefore described.

To assemble the described coupler 40, each of the respective conduits are fitted with the fastening nut 46, compression ring 48 and sealing gland 47 in the manner hereinbefore described. With the nut 46, compression ring 48 and sealing gland 47 so positioned on the end of a conduit, the end of the conduit is inserted into one end portion of the coupling body 42 until the conduit is seated or abuts the stop shoulder 45. The fastening nut 46 is then threaded onto its respective end portion until the sealing gland 47 has wedged itself into sealing relationship between the coupling body 42 and the conduit, and the compression ring 48 is tightly compressed onto the conduit as hereinbefore described.

From the foregoing, it will be apparent that a fluid tight and a pressure tight connection is effected between the connector or coupler body and its corresponding conduit whereby any pullout or separation of the conduit is positively prohibited and at the same time provides for a positive electrical grounding of the conduit and the associated connector or coupler body.

While the invention has been described with respect to several embodiments thereof, it will be understood that variations and modifications may be made without departing from the spirit or scope of the invention.

1. A connecting assembly comprising:
a connecting body having a bore therein defining opposed openings,
at least one of said openings being adapted to receive an electrical metal conduit,
said bore defining said one opening having a first linear length and a second linear length,
said first linear length being of uniform shape and size to receive an end portion of the electrical metal conduit, and
said second linear length having an internal tapered surface that diverges outwardly toward said one opening,
a plastic sealing gland sized to be fitted onto the end portion of the electrical metal conduit,
said plastic sealing gland having an outer tapering surface that complements the internal taper of said second linear length,
a metallic split compression ring adapted to be loosely fitted onto the end portion of the electrical metal conduit,
and a fastening nut fitted onto the end portion of an the electrical metal conduit for securing the metal conduit to said one opening whereby said plastic sealing gland is urged into sealing relationship with said tapered surface of the second linear length and said metallic compression ring into compression and electrical grounding relationship with the metal conduit.

2. A connecting assembly as defined in claim 1 and including an internal stop shoulder defining the stop to limit the distance a metal conduit is inserted into said one opening, and
an intermediate shoulder longitudinally spaced from said stop shoulder to define said first linear length of said bore from said second linear length of said bore.

3. A connecting assembly as defined in claim 1 wherein said first linear length of said bore has an internal diameter sized and shaped to snugly receive the end portion of the metal conduit.

4. (Canceled).

5. A connecting assembly as defined in claim 1 wherein said split compression ring is provided with a transverse inverted U-shape cross-section, and a transverse slot to define slightly spaced apart opposed ends.

6. (Canceled).

7. A connecting assembly as defined in claim 1 wherein the other of said opposed openings includes a first and second portion, similar to said first and second portions of said one opening, whereby said other opening is adapted to receive a second metal conduit, and
a second sealing gland fitted onto the end of a second conduit,
a second split compression ring loosely fitted onto a second conduit, and
a second fastening nut for securing the second conduit to said connecting body whereby said second sealing gland is urged into sealing relationship with said second portion of said other opposed opening and said compression ring into compression and electrical grounding relationship with the second conduit.

8. An electrical connector comprising:
a connector body having an inlet end and an outlet end,
a bore extending through said inlet end and outlet end to define opposed end openings,
said inlet end being externally threaded,
said inlet end having a first linear length and a second linear length,
said first linear length having an internal surface,
an electric metal conduit having an end portion,
said internal surface of said first linear length being sized and shaped to snugly receive said end portion of said conduit,
said second linear length having an internal surface which diverges outwardly toward said inlet end opening,
a plastic sealing gland fitted onto the end portion of said conduit,
said plastic sealing gland having a tapered outer surface that complements the internal surface of said second linear length,
a metallic split compression ring circumscribing said end portion of said conduit,
said split compression ring having inwardly extending offset lips extending about the opposed periphery of said split compression ring,
and an internally threaded fastening nut disposed on said end portion of said conduit for securing said conduit to said inlet end whereby said sealing gland is urged in fluid tight relationship with said second linear length and said compression ring is compressed onto said conduit to positively secure said conduit to said connector body and electrically ground said conduit as said fastening nut is tightened.

9. An electrical connector as defined in claim 8 and including a resilient washer fitted onto the outlet end of the connector body adapted to be inserted through a knock out hole of a junction box, and
means for securing said outlet end to the junction box whereby said resilient washer is urged into sealing position about the outlet end.

10. (Canceled).

11. (canceled).

12. (Canceled).

13. An electrical connector comprising:
a connector body having an inlet end and an outlet end,
a bore extending through said inlet end and outlet end to define opposed end openings,
said inlet end being externally threaded,
said inlet end having a first linear length and a second linear length,
said first linear length having an internal surface,
an electric metal conduit having an end portion,
said internal surface of said first linear length being sized and shaped to snugly receive said end portion of said conduit,
said second linear length having an internal surface which diverges toward said inlet end opening,
a plastic sealing gland fitted onto the end portion of said conduit,
said sealing gland having a tapered outer surface that complements the internal surface of said second linear length,
a metallic split compression ring circumscribing said end portion of said conduit,
and an internally threaded fastening nut disposed on said end portion of said conduit for securing said conduit to said inlet end whereby said plastic sealing gland is urged in fluid tight relationship with said internal surface of said second linear length and said compression ring is compressed onto said conduit to positively secure said conduit to said connector body and electrically ground said conduit as said fastening nut is tightened,
said compression spring ring includes a transverse cut defining spaced apart opposed ends that are longitudinally extended and disposed in a common plane to define a split ring of 360°,
said compression ring includes opposed peripheral edges that are slightly bent to define radially and inwardly extending lips that extend about said ring to engage said conduit when in compression,
a resilient washer fitted onto the outlet end of the connector body adapted to be inserted through a knock out hole of a junction box, and
means for securing said outlet end to the junction box whereby said resilient washer is urged into sealing position about the outlet end.

14. An electrical coupling assembly comprising:
a coupling body,
a bore extending through said body and defining opposed end portions terminating in opposed open ends,
a radially outwardly extending flange circumscribing said coupling body between said open ends,
an internal shoulder forming a stop intermediate of said bore,
each of said opposed end portions having a first portion and a second portion,
said first portion of each of said opposed end portions having an internal surface sized and shaped to receive an end portion of an electrical metal conduit,
and said second portion having an internal surface which diverges toward the associated open end,
a split, 360 degree compression ring adapted to be fitted onto an end portion of an electrical metal conduit,
a sealing gland adapted to be fitted onto an end portion of an electrical metal conduit,
and a fastening nut adapted to be fitted onto an end portion of an electrical metal conduit for securing an electrical conduit to a corresponding end portion whereby said sealing gland is wedged into sealing relationship to its corresponding second portion and said compression ring is compressed onto its associated conduit to positively secure and electrically ground a connected conduit as the fastening nut is tightened onto its associated end portion.
